(19) United States
(12) Patent Application Publication
(10) Pub. No.: US 2015/0100364 A1
(43) Pub. Date: Apr. 9, 2015

(54) MINIMIZING LEAD CREATION TO CONTACT TIME IN A SALES FORCE

(71) Applicant: Boston Logic Technology Partners, Inc., Boston, MA (US)

(72) Inventors: David G. Friedman, Boston, MA (US); Thomas M. Cocca, Boston, MA (US); Joseph H. Heald, Quincy, MA (US)

(21) Appl. No.: 14/501,616

(22) Filed: Sep. 30, 2014

Related U.S. Application Data
(60) Provisional application No. 61/886,098, filed on Oct. 3, 2013.

(51) Int. Cl. G06Q 10/06

(52) U.S. Cl. CPC G06Q 10/063118
USPC 705/7.17

(57) ABSTRACT

A computer system is used to minimize the time between when information about a lead, i.e., a potential buyer, is first received and when that lead is first contacted by a sales agent. A form of competition is used to allow one sales agent, from among many sales agents, to be enabled to be the first to contact a lead based on how quickly that sales agent responds to a notification that the lead is available. The system can allow the sales agent to first claim a lead, then contact the lead; or, the system can put the first sales agent to respond in contact with the lead.

### CROSS-REFERENCE TO RELATED APPLICATIONS

This application is a nonprovisional application of provisional patent application Ser. No. 61/886,098, filed Oct. 3, 2013.

### BACKGROUND

One challenge in real estate is connecting potential buyers, sellers, and renters with agents to serve them. While this problem is not unique to selling real estate, some aspects of the real estate purchasing process are. For example, a buyer may affiliate themselves with an agent, who provides them access to a variety of properties, some of which may be represented by yet another seller's agent. Agents generally specialize in properties by geographical area, property type and price range. Agents generally work within agencies or brokerages, which, on average, have about ten agents.

In many sales processes, time is of the essence in closing a sale. Buyers generally react positively to prompt service and often stay with the first sales agent with whom they have a positive interaction. Thus, it is in an agency's interest and individual agent's interest to respond as quickly as possible to potential leads for buyers, and to be responsive.

### SUMMARY

This Summary introduces selected concepts in simplified form that are further described below in the Detailed Description. This Summary is intended neither to identify key or essential features of the claimed subject matter, nor to limit the scope of the claimed subject matter.

A computer system, computer program, and computer-implemented process provide ways to minimize time between when an agency first learns about a lead, i.e., a potential buyer, seller, or renter, and when that lead is first contacted by a sales agent from the agency. The technology is used to enable a form of competition to occur, allowing one sales agent from among many to be enabled to be the first to contact a lead based on how quickly that agent responds to a notification that the lead is available.

In particular, data defining a lead is received into storage of a computer system. Such data can come from a variety of different sources. For example, a potential buyer may be searching for properties on a web-based real estate search engine and may request more information about a property. A potential buyer may be searching for properties on an agency's web site and request more information. A potential buyer may email an agency or otherwise contact an agency through telephone or other communication media to request information about buying a property. A lead also can be a potential seller seeking to affiliate with an agent to assist in selling a property.

Information about availability of the lead is then communicated from the computer system to devices associated with sales agents. For example, text messaging, electronic mail, instant messaging and the like can be used to communicate this information to sales agents or lead response personnel, through their mobile devices, smart phones, tablet computers, desktop computers, laptop computers and other similar devices.

Sales agents, from their various devices, can respond to this information. Through their devices, response messages are sent back to the computer system. These response messages are received by the computer system from the devices and can be stored in storage of the computer system.

The computer system identifies which of the response messages related to a particular lead is the first response message to be received for that lead, and determines which sales agent is the first sales agent to have responded to information about the lead. The computer system then enables only the identified first sales agent to initiate communication with the lead. More precisely, the devices for the sales agent are enabled to initiate communication with devices associated with the lead.

The sales agents to whom information about a lead is sent can be limited to those sales agents that match a lead. For example, a sales agent may be assigned to properties of a particular type, geographic region, price range or the like. Similar information about a lead also can be obtained, such as the property type, geographic region and price range. The system identifies sales agents for which one or more of the product category, the price range, and so on, match those of the lead.

In one implementation, various information about leads, sales agents and their relationships are stored in a customer relationship management system. In one implementation, the first sales agent that responds to information about a lead is assigned to the lead in a customer relationship management system. In one implementation, the sales agent “clicks to claim” the lead, by manipulating data within the message about the lead that is received on the sales agent's device, and causes the lead to be assigned to the sales agent.

In one implementation, after the lead is assigned to the first sales agent, then a message is sent to the one or more devices associated with the identified first sales agent with contact information associated with the lead. The sales agent, through the device, can manipulate the contact information and initiate contact with the lead. In one implementation a message is received by the computer system from the sales agent's device indicating a desire to initiate communication with the lead. In response to the message, a communication is initiated between a device of the identified first sales agent and a device of the lead. In one implementation, the sales agent “clicks to call” the lead, by manipulating contact information within the message about the lead that is received on the sales agent's device.

In another implementation, in response to the first received message, a communication is initiated between a device for the identified first sales agent and a device for the lead. The lead also is assigned to the identified first sales agent in a customer relationship management system. In one implementation, a single “click” causes the sales agent to both claim and call the lead.

To initiate communications between sales agents and leads, in one implementation, a telecommunications service initiates a telephone call from the telecommunications service to the device for the identified first sales agent, and, after connecting with the device of the identified first sales agent, the telecommunications service then initiates a telephone call to the device for the lead, and then bridges the two calls. An indication of occurrence of the telephone call also can be stored in the customer relationship management system. A transcript of the telephone call can be prepared and stored in the customer relationship management system.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example system in which leads are assigned to agents.

FIG. 2 is a more detailed block diagram illustrating an example implementation of such a system.

FIG. 3 is a flow chart of an example implementation of selecting a set of sales agents.

FIG. 4 is a flow chart of an example implementation of assigning an agent to a lead.

FIG. 5 is a flow chart of an example implementation of initiating contact between an agent and a lead.

FIG. 6 is a flow chart of an example implementation of initiating contact between an agent and a lead.

FIG. 7 is a block diagram of an example computer system.

### DETAILED DESCRIPTION

The following section provides an example operating environment in which a sales optimization system can be implemented.

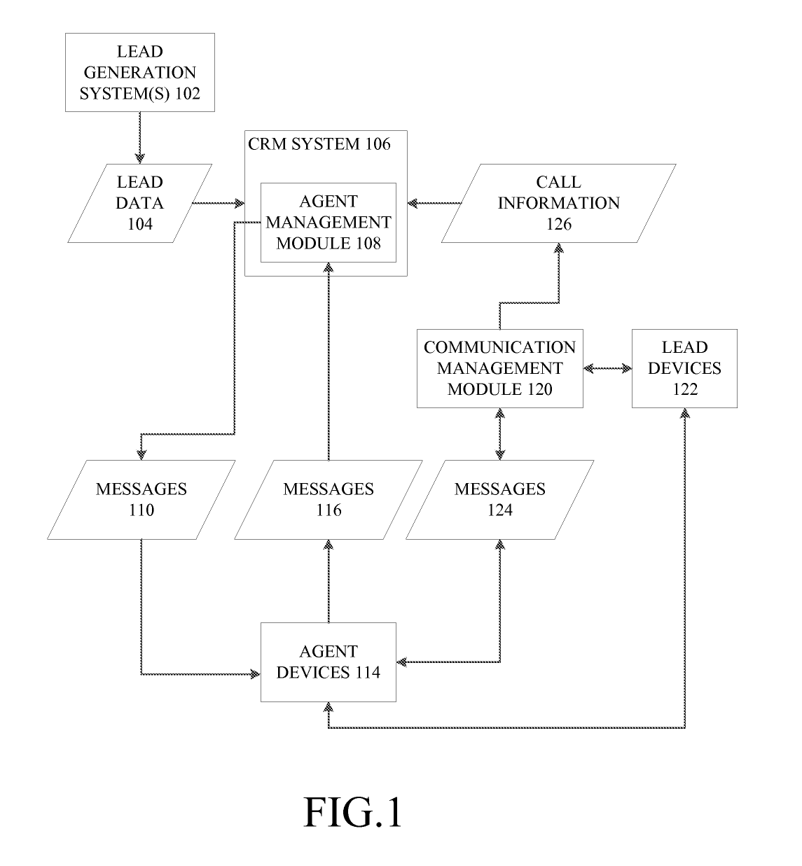

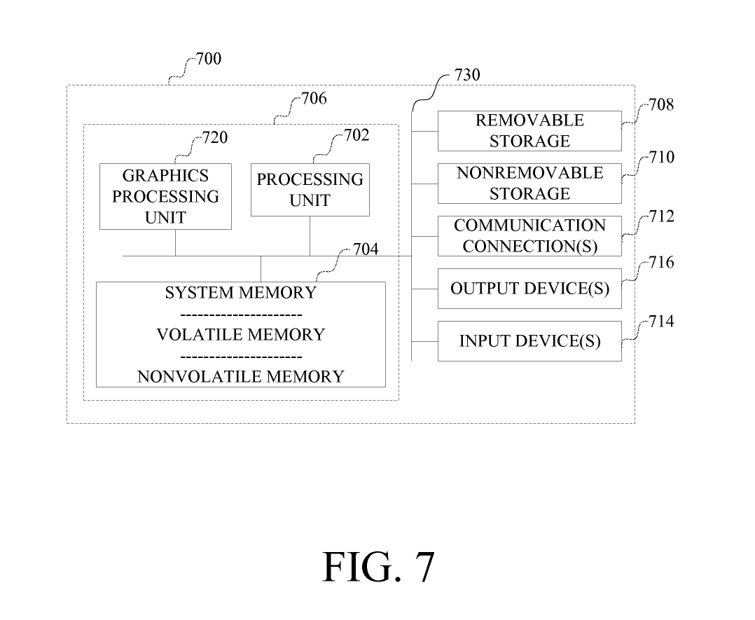

Referring to FIG. 1, a system 100 includes a lead generation system 102 that produces data 104 about leads. The lead generation system can include a plurality of different computer systems (such as a computer described in FIG. 7 below) and lead sources and is illustrated as a singular component for ease of description and illustration only. For example, leads can arrive though electronic mail, web-based interfaces, direct data entry, and the like. Data 104 about leads can be a plurality of different formats, depending on the lead source. However, data 104 about a lead can include, for example, a name, contact information and information about the product or service in which the lead is interest. For example, in real estate, the information can include a specific property, or a description of properties, such as a geographic areas, property types and/or price ranges.

For example, a potential buyer may be searching for properties on a web-based real estate search engine and may request more information about a property. A potential buyer may be searching for properties on an agency's web site and request more information. A potential buyer may email an agency or otherwise contact an agency through telephone or other communication media to request information about buying a property. A lead also can be a potential seller seeking to affiliate with an agent to assist in selling a property.

Data 104 about a lead is stored in a customer relationship management system 106. A customer relationship management system can be implemented using a computer such as described below in connection with FIG. 7 configured by computer programs that implement the customer relationship management system on one or more computers. There are a variety of commercially available computer programs for implementing a CRM system that can be modified so as to incorporate the functionality as described herein. The CRM system can be implemented on one or more server computers that are accessed over a computer network (not shown) by multiple users using client computer systems (not shown).

Data about sales agents also can be stored in the customer relationship management system. For example, each sales agent can have a profile comprising a name, contact information, and products or services supported. For example, in real estate, the information can be specific properties, or a description of properties, such as geographic areas, property types and/or price ranges.

After the data 104 about a lead is received, an agent management module 108 (shown in this example as implemented within the CRM system) manages associating the lead with a sales agent. The agent management module can be implemented using one or more computers, such as described below in connection with FIG. 7, as configured by one or more computer programs that implement the functionality described herein. The agent management module can be implemented on the same computer and as part of as the customer relationship management system as shown or on a different computer or separately from the CRM system.

In general, the agent management module 108 sends messages 110 over a communication link 112 to sales agent devices 114. The sales agent devices 114 receive messages and allow a sales agent to manipulate received messages. Similarly, sales agent devices 114 send messages 116 over the communication link 112 to the agent management module 108. Agent management module 108 receives and processes such messages to implement a variety of functions, such as those described in more detail below. For example, messages 110 can contain information about a lead to be claimed or contact information for a lead. Messages 116 can include messages sent to claim a lead.

Each sales agent device generally is implemented in the form of a computer, such as a laptop computer, mobile phone, tablet computer and the like. Messages are received by such devices generally through communications systems such as electronic mail, SMS text messages, cellular telephone call and the like. Thus, the communication link generally is a form of wired or wireless connection to one or more of an internet communication link, cellular communication link or telephone system link.

A communication management module 120 also manages communication between sales agent devices 114 and devices 122 associated with leads. There are a variety of implementations of such a module, examples of which are described in more detail below. In general, a sales agent sends messages 124 through a sales agent device 114 to the communication management module 120 (whether directly as shown or indirectly through the agent management module) to request initiation of communication with a lead. The communication management module 120 tracks information 126 about the communication in the customer relationship management system 106. Such information can include log data about the call, and even transcripts or recordings of the call given notice to and/or consent from the lead. The communication management module 120 also can send and receive messages with the devices 122 of leads to initiate communication between those devices and the sales agent device 114.

An example implementation of the communication management module 120 is a server computer, such as described in FIG. 7, configured by a computer program that implements a communication protocol and an application programming interface through which commands related to telephone calls can be received, for example from other computers over a computer network. Using the communication protocol, another computer can instruct the server computer to initiate phone calls, bridge phone calls, record and transcribe phone calls, and the like. Such a server computer connects to a telephone system as well. An example of such a system includes but is not limited to the Twilio call management system available through Twilio, Inc.

Using such a system, the agent management module and communication management module coordinate, through a set of processes, to provide ways to minimize time between when an agency first learns about a lead, i.e., a potential buyer, and when that lead is first contacted by a sales agent from the agency. The technology enables a form of competition to occur, allowing one sales agent from among many to be enabled to be the first to contact a lead based on how quickly that agent responds to a notification that the lead is available. The system identifies which of the response messages related to a particular lead is the first response message to be received for that lead, and determines which sales agent is the first sales agent to have responded to information about the lead. The computer system then enables only the identified first sales agent to initiate communication with the lead. More precisely, the devices for the sales agent are enabled to initiate communication with devices associated with the lead.

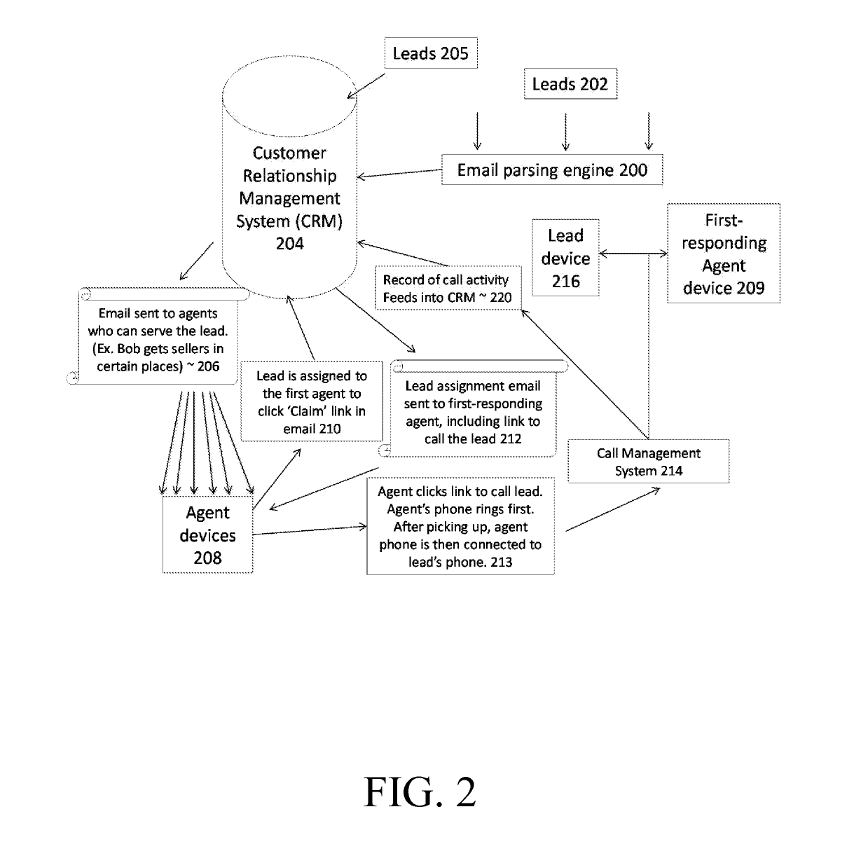

More details of an implementation of such a system is shown in FIG. 2. This implementation includes an email parsing engine 200 that processes leads 202 that arrive through an electronic mail system (not shown) from a variety of sources. Lead information 205 also can come from a variety of other sources. Information from each lead is extracted and stored in a customer relationship management (CRM) system 204.

The CRM system 204 includes a module (not shown) that processes each lead email to manage assignment of that lead to a sales agent. In particular, an email 206 or other communication is sent to multiple sales agents through their agent devices 208, which are associated with the sales agent in the CRM system.

The sales agents to which the message is delivered can be all the sales agents registered in the system, or a selected subset based on matching information about the lead with information about the sales agents. For example, a sales agent may be assigned to properties of a particular type, geographic region, price range or the like. Similar information about a lead also can be obtained, such as the property type, geographic region and price range. The system identifies sales agents for which one or more of the product category, the price range, and so on, match those of the lead.

Each sales agent responds to messages on their own agent device. The first sales agent to respond to the message to claim the lead is assigned that lead in the CRM system as indicated at 210. For example, the message can include a button or other user interface element which is labeled with something like “click to claim” and can be manipulated by the user. When the sales agent manipulates the button as displayed on their agent device, a message is sent from the agent device to the CRM system indicating that sales agent intends to claim the lead. The first sales agent from which a response is received by the CRM system is assigned the lead.

Next, the CRM system sends a lead assignment message 212, such as an email message to the agent device for the sales agent that claimed the lead. The message can include a button, for example, or other user interface element, which is labeled something like “click to call”. When the sales agent manipulated the button as displayed on their agent device, a message 213 is sent from the agent device to a call management system 214. The call management system 214 initiates a telephone call to the first responding agent's device 209, then to the device 216 of the lead. Recording or transcription, with proper notice and consent, of the call can then occur. Information 220 about the call then can be stored in the CRM system.

In another implementation, in response to the first received message, a communication is initiated between a device for the identified first sales agent and a device for the lead. The lead also is assigned to the identified first sales agent in a customer relationship management system. In one implementation, a single “click” causes the sales agent to both claim and call the lead.

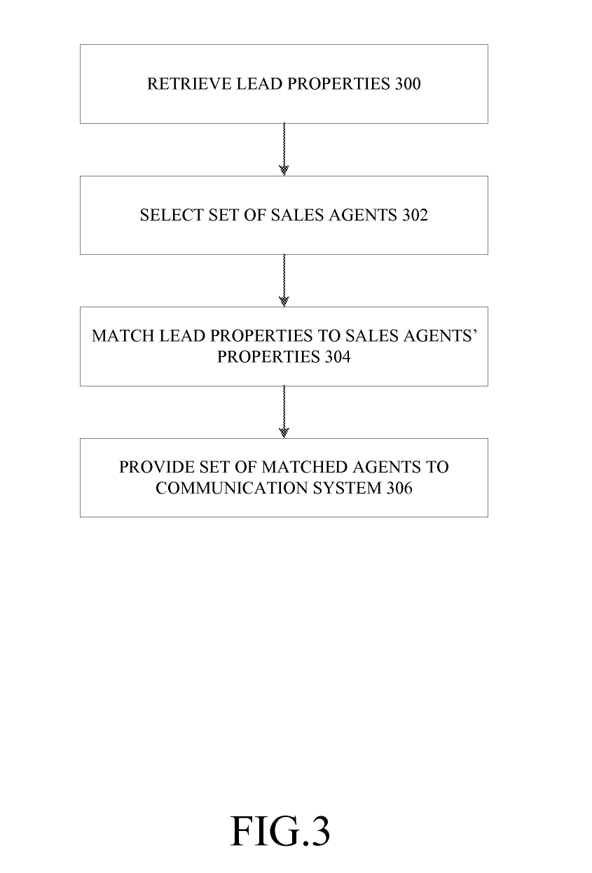

A database structure and flowcharts describing operation of an example implementation of such a system will now be described in more detail in connection with FIGS. 3-6.

The CRM system maintains a variety of information about leads, agents and other information in order to support the agents' operations. In this example, a database structured by tables will be described. In one implementation, information about leads can include one or more database tables containing contact information and information about the interests of the lead. In particular, for each lead, the database stores data indicating the agent, if any, assigned to the lead. When a new lead is added to the database, the processes described below are initiated. Leads can be added to a queue and then processed from the queue to assign each lead an agent.

A lead event history table also can be maintained to indicate various actions that are taken by the system and associated with each lead. In one implementation such a table includes a lead identifier column, an agent identifier column, and an action identifier column, thus enabling identification of actions by lead, by agent or by action type. Such actions can include items such as, but not limited to, adding the lead to the CRM system, assigning an agent to the lead, the agent contacting the lead, status changes, etc.

In one implementation, information about agents can be stored in one or more database tables. Such information can include, but is not limited to, an agent identifier, contact information for the agent, distribution or search criteria for the agent such as their geographic regions, price ranges, property types, and the like.

In FIG. 3, selection of a set of sales agents to which a lead is offered is described. In this implementation, sales agents having properties matching a lead are selected. There are a variety of ways in which such properties can be matched, include exact matches, partial matches, similarity metrics and the like. Properties of a lead are first retrieved 300. Such properties can include, but are not limited to, a product type, a price range and a geographic area. Such properties are typical for real estate. In real estate, the property type can include, for example, rental, residential, commercial, condominium, single family home, and the like. The invention is not limited to any particular set of properties or taxonomy of properties. A set of sales agents is then selected 302 for matching. This may be all of sales agents registered in a system, or a subset of such sales agents. The properties of the lead are then matched 304 to the properties of the sales agent in the selected set. The matching can be performed in a variety of ways. For example, matching can be limited to identifying all sales agents having an exact match with all properties of a lead. As another example, a match can be found if one property of the sales agent matches a property of the lead. The set of matched leads is then provided 306 to a communication system.

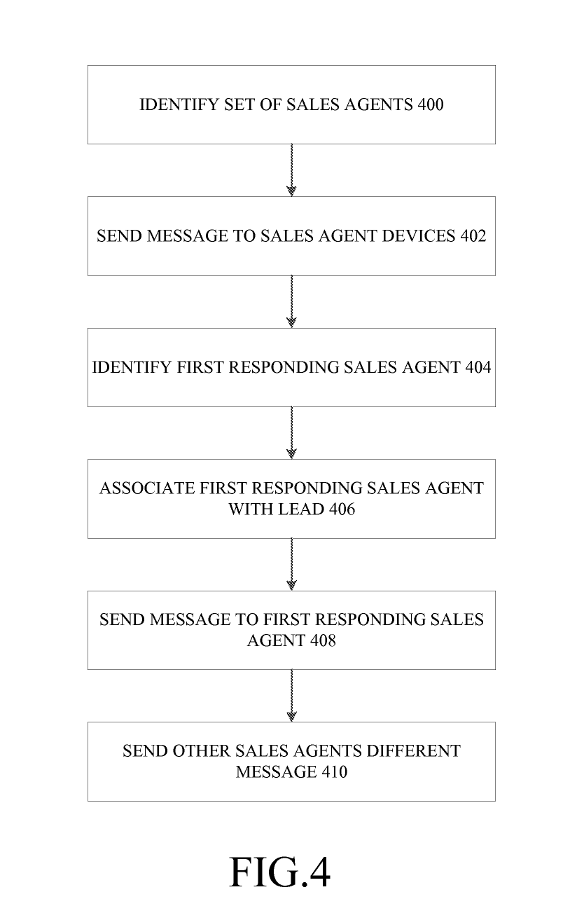

Referring now to FIG. 4, an example implementation of a process for assigning the lead to a sales agent. The set of sales agents to which the lead will be offered is identified 400. A message is sent 402 to each of the sales agents' devices, indicating the availability of the lead. The system manages receiving response messages from the sales agents' devices. In particular, the system identifies 404 the sales agent associated with the first received response message. The identified sales agent is associated 406 with the lead. A message can be sent 408 to the sales agent, indicating that the sales agent successfully claimed the lead, for example, optionally including contact information for the lead. For example, the agent may be logged into the CRM system and presented a lead information page in a browser on the agent device, which page includes the contact information for the lead. Responses from other sales agents can optionally result in a response message being sent 410 indicating that they did not act quickly enough to claim the lead.

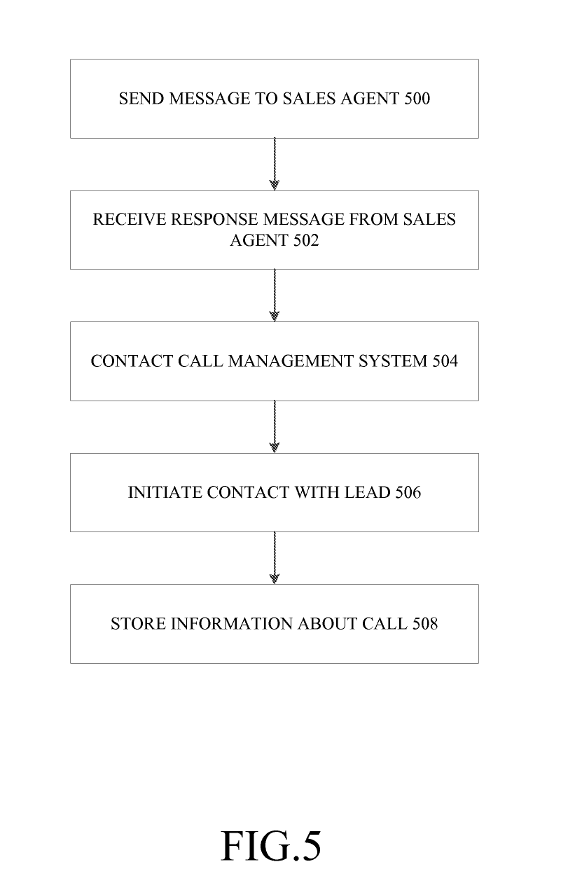

Referring now the FIG. 5, an example implementation of a process for initiating contact with the lead. In this implementation, after the sales agent is informed that the lead has been successfully claimed, the sales agent receives a message offering the sales agent the ability to contact the lead through a call management system. Thus, the process in FIG. 5 includes sending 500 a message to the sales agent offering the sales agent the opportunity to contact the lead. For example, the message can include a “click to call” button or contact information or instructions for contacting the lead through a call management system. The system receives 502 a response message requesting contact to be initiated with the lead. The system contacts 504 a call management system to manage the call. For example, such contact can include a message with the information of the sales agent's device, the lead's device and instructions regarding the call. The call management system initiates 506 contact with the lead. For example, the call management system can contact the sales agent's device, and, after a connection is made, then contact the lead's device. After contact is made with the lead's device, then the connection between the lead's device and sales agent's device can be bridged. The call management system also can update 508 a customer relationship management system with information about the call.

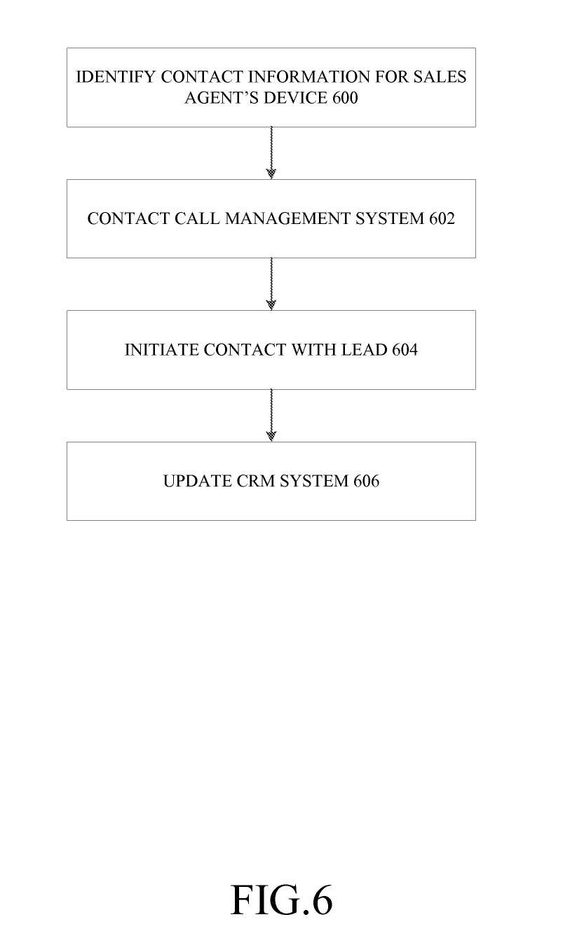

Referring now to FIG. 6, an example implementation of an alternative process for connecting with the lead is described. In this example, the action to claim a lead is merged with the attempt to contact the lead. Thus, in response to the system identifying the first sales agent to respond, in addition to informing the sales agent that the lead was successfully claimed, the system informs the sales agent that a contact will be initiated. The system identifies 600 contact information for the sales agent's device and for the lead's device and then contacts 602 the call management system to manage the call. The call management system initiates 604 contact with the lead, such as described above. The call management system also can update 606 a customer relationship management system with information about the call.

As can be seen from the above, the system encourages competition among the sales agents to respond quickly to identified leads, and enables those leads to be promptly contacted. All information about the claiming of and contact with leads can be tracked in a customer relationship management system. Such a process can reduce the time between lead generation and contact with a lead.

Having now described an example implementation, a general purpose computer in which components of such a system can be implemented will now be described. The following description is intended to provide a brief, general description of a suitable computer with which components of this system can be implemented. The system can be implemented with numerous general purpose or special purpose computing hardware configurations. Examples of well known computers that may be suitable for any given component include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

FIG. 7 illustrates an example computer 700. A computer 700 typically includes at least one processing unit 702 and memory 704. The computer may include multiple processing units and/or additional co-processing units such as graphics processing unit 720. Memory 704 may be volatile (such as RAM), non-volatile (such as ROM, flash memory, etc.) or some combination of the two. This configuration is illustrated in FIG. 7 by dashed line 706.

Computer 700 may include additional storage (removable and/or non-removable) including, but not limited to, magnetic or optical disks or tape. Such additional storage is illustrated in FIG. 7 by removable storage 708 and non-removable storage 710. Computer storage media includes volatile and nonvolatile, removable and non-removable media implemented in any method or technology for storage of information such as computer program instructions, data structures, program modules or other data. Memory 704, removable storage 708 and non-removable storage 710 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computer 700. Any such computer storage media may be part of computer 700. A storage medium is any addressable medium in which data can be stored in and retrieved from physical storage locations by the computer.

Computer 700 may also contain communications connection(s) 712, which are interface devices that allow a computer to connect to and communicate with other devices over a communication medium. By way of example, and not limitation, communication media includes wired media such as a wired network or direct-wired connection, and wireless media such as acoustic, RF, infrared and other wireless media.

Computer 700 may have various input device(s) 714 such as a keyboard, mouse, pen, camera, touch input device, and so on. Output device(s) 716 such as a display, speakers, a printer, and so on may also be included. All of these devices are well known in the art and need not be discussed at length here.

The various components in FIG. 7 are generally interconnected by an interconnection mechanism, such as one or more buses 730.

Components of such a system may be implemented using specially designed hardware components using software on a general purpose programmable computer, including computer-executable instructions and/or computer-interpreted instructions, such as program modules, being processed by the computer. Generally, program modules include routines, programs, objects, components, data structures, and so on, that, when processed by a processing unit, configure the computer to perform particular tasks or implement particular abstract data types or implement particular components. This system may be practiced in distributed computing environments where tasks are performed by remote processing devices that are linked through a communications network. In a distributed computing environment, program modules may be located in both local and remote computer storage media including memory storage devices.

It should be understood that the subject matter defined in the appended claims is not necessarily limited to the specific implementations described above. The specific implementations described above are disclosed as examples only.

What is claimed is:

1. A computer-implemented process, comprising:
receiving data defining a lead into storage of a computer system;
communicating information about availability of the lead from the computer system to devices associated with a plurality of sales agents;
receiving, from the devices and into storage of the computer system, one or more response messages related to the lead;
the computer system identifying a first sales agent having a device from which a first of the response messages related to the lead is received; and
the computer system enabling only one or more devices associated with the identified first sales agent to initiate communication with a device associated with the lead.

2. The computer-implemented process of claim 1, wherein communicating comprises:
identifying sales agents matching the lead; and
sending the information about availability of the lead to the devices associated with the identified sales agents.

3. The computer-implemented process of claim 2, wherein a sales agent has a product category and price range, and the lead has contact information, a product category and a price range.

4. The computer-implemented process of claim 3, wherein identifying sales agents comprises identifying sales agents having the product category and the price range that match the product category and price range of the lead.

5. The computer-implemented process of claim 1, further comprising assigning the lead to the identified first sales agent in a customer relationship management system.

6. The computer-implemented process of claim 1, wherein enabling comprises sending a message to the one or more devices associated with the identified first sales agent with contact information associated with the lead.

7. The computer-implemented process of claim 6, wherein enabling comprises:
receiving a message from one of the devices associated with the identified first sales agent indicating selection of the contact information to initiate communication with the lead;
in response to the message, initiating a communication between a device of the identified first sales agent and a device of the lead.

8. The computer-implemented process of claim 1, wherein enabling comprises initiating a communication between a device of the identified first sales agent and a device of the lead.

9. The computer-implemented process of claim 8, further comprising assigning the lead to the identified first sales agent in a customer relationship management system.

10. The computer-implemented process of claim 1, wherein enabling comprises:
in response to the first received message, initiating a communication between a device for the identified first sales agent and a device for the lead; and
assigning the lead to the identified first sales agent in a customer relationship management system.

11. The computer-implemented process of claim 10, wherein initiating the communication comprises:
using a telecommunications service, initiating a telephone call from the telecommunications service to the device for the identified first sales agent, and, after connecting with the device of the identified first sales agent, the telecommunications service then initiating a telephone call to the device for the lead.

12. The computer-implemented process of claim 11, further comprising assigning the lead to the identified first sales agent in a customer relationship management system.

13. The computer-implemented process of claim 12, further comprising storing an indication of occurrence of the telephone call in the customer relationship management system.

14. The computer-implemented process of claim 11, further comprising preparing a transcript of the telephone call and storing the transcript in the customer relationship management system.

15. A computer system, comprising:
a communication connection for communicating with devices of sales agents;
storage for storing information about leads;
one or more processors being configured to:
receive data defining a lead into storage of a computer system;
communicate information about availability of the lead from the computer system to devices associated with a plurality of sales agents;
receive, from the devices and into storage of the computer system, one or more response messages related to the lead;
identify a first sales agent having a device from which a first of the response messages related to the lead is received; and
enable only one or more devices associated with the identified first sales agent to initiate communication with a device associated with the lead.

16. The computer system of claim 15 further including a customer relationship management system, the customer relationship management system storing associations between sales agents and leads.

17. The computer system of claim 16, wherein the one or more processors are further configured to receive a message from one of the devices associated with the identified first sales agent indicating selection of the contact information to initiate communication with the lead, and in response to the message, initiate a communication between a device of the identified first sales agent and a device of the lead.

18. The computer system of claim 15, wherein the one or more processors are further configured to initiate a communication between a device of the identified first sales agent and a device of the lead.

19. The computer system of claim 18, wherein the one or more processors are configured to assign the lead to the identified first sales agent in a customer relationship management system.

20. The computer system of claim 15, wherein the one or more processors are further configured to, in response to the first received message, initiate a communication between a device for the identified first sales agent and a device for the lead, and to assign the lead to the identified first sales agent in a customer relationship management system.
